(19) United States
(12) Patent Application Publication
(10) Pub. No.: US 2017/0301134 A1
(43) Pub. Date: Oct. 19, 2017

(54) METHOD FOR CREATING THREE-DIMENSIONAL DOCUMENTATION

(71) Applicant: AVL LIST GMBH, GRAZ (AT)

(72) Inventors: Gerald Stieglbauer, Graz (AT); Peter Mohr, Graz (AT); Bernhard Kerbl, Graz (AT); Denis Kalkofen, Graz (AT); Michael Donoser, Berlin (DE); Dieter Schmalstieg, Graz (AT)

(73) Assignee: AVL LIST GMBH, GRAZ (AT)

(21) Appl. No.: 15/513,057

(22) PCT Filed: Sep. 17, 2015
(86) PCT No.: PCT/EP2015/071317

§ 371 Date: Mar. 21, 2017

(30) Foreign Application Priority Data
Sep. 22, 2014 (AT) A50672/2014

(51) Int. Cl. G06T 17/30; G06F 17/50; G06T 15/00; G06T 17/10

(52) U.S. Cl. CPC G06T 17/30; G06T 17/10; G06F 17/50; G06T 15/005

(57) ABSTRACT

To allow simple creation of three-dimensional documentation for a utility article (1) made up of multiple parts (T), image parameters (BP) of at least one illustration (A) of the utility article (1) in existing two-dimensional documentation (2) are ascertained, a 3D model (M) of the utility article (1) with the ascertained image parameters (BP) is aligned with the illustration (A), and, based on a comparison of the two-dimensional illustration (A) and of the 3D model (M) to the ascertained image parameters (BP) from the two-dimensional illustration (A), additional information is obtained, which together with the 3D model (M) forms the three-dimensional documentation (10) of the utility article (1).

The present invention relates to a method for creating three-dimensional documentation for a utility article made up of multiple parts.

Documentation such as handbooks, operating manuals, assembly instructions, repair instructions, training documents, etc., for various utility articles ranging from household appliances, toys, machines, and machine components to highly complex technical devices is present in the majority of cases in printed form or in a digital equivalent, for example as a pdf file or html file. Such documentation generally contains various two-dimensional illustrations of the utility article, on the basis of which a user of the utility article is to understand the functioning of the utility article or receive instructions for using the utility article. An illustration may be a simple view, an isometric drawing, or even a photograph of a view of the utility article. Such illustrations in printed documentation are necessarily two-dimensional representations of various views of the utility article. When using the documentation, the user of the utility article must therefore transfer two-dimensional views to the actual three-dimensional utility article, which is a quite complex mental challenge, and which for many persons represents a problem due to little or no ability to visualize in three dimensions.

This situation may be improved by using documentation in three-dimensional form, in which the utility article is represented in three dimensions, for example on a display unit, with the view of the utility article being arbitrarily changeable.

A further improvement may be realized using augmented reality. Augmented reality is generally understood as a person's actual sensory perception of reality, in particular what is seen, heard, or felt, in order to expand or supplement with additional information. This additional information may likewise be conveyed to a person visually, acoustically, or haptically. For example, the utility article is recorded using a recording unit, for example a digital camera of a smart phone or a tablet PC, a 3D scanner, etc., and the recorded view of the utility article is supplemented with additional information in real time, for example by superimposing it on the recorded and displayed image or by playing back acoustic information. In addition, the representation is automatically adapted when the relative position between the recording unit and the utility article changes.

Approaches currently exist for providing documentation of utility articles in three dimensions, also using augmented reality. However, creating three-dimensional documentation of a utility article is a very complex, time-consuming task, in particular when three-dimensional animations, possibly also in real time (such as in augmented reality) are desired as well. This requires an experienced 3D designer and specialized software products for animation. For this reason, three-dimensional documentation or augmented reality documentation has not become established thus far.

It is an object of the present invention to provide a method for easily creating three-dimensional documentation for a utility article for which only two-dimensional documentation is available.

This object is achieved according to the invention in that image parameters of at least one illustration of the utility object in existing two-dimensional documentation are ascertained, a 3D model of the utility article is aligned with the image with the ascertained image parameters, and, based on a comparison of the two-dimensional illustration and of the 3D model with the ascertained image parameters from the two-dimensional illustration, additional information is obtained, which together with the 3D model forms the three-dimensional documentation of the utility article. This procedure allows analysis of illustrations in existing two-dimensional documentation in order to obtain additional information therefrom which may then be superimposed on arbitrary views of the 3D model. It is irrelevant whether the two-dimensional documentation is present in the form of existing printed documentation with two-dimensional imaging that can be used for the method according to the invention, or whether the two-dimensional documentation is created only for the generation of the three-dimensional documentation.

To be able to easily determine the image parameters, a plurality of corresponding points is selected in the illustration and in the 3D model, and the image parameters are varied until the illustration and the 3D model are aligned. A suitable criterion for determining sufficient alignment may be established for this purpose.

For determining a guide line, contiguous components are ascertained in the illustration, the eccentricities of the contiguous components are ascertained, and the ascertained eccentricities are compared to a predefined threshold value in order to identify at least one candidate for a guide line. A straight line that represents the guide line is subsequently drawn into the contiguous component of the candidate in a longitudinal direction of the region, and based on a mask of the utility article obtained from the 3D model, it is ascertained which end point of the straight line lies in the utility article. This method may be carried out in an automated manner using digital image processing methods, thus allowing guide lines to be identified very easily as additional information.

If a search region, which is examined for annotation text using optical character recognition software, is defined around the other end point of the straight line, the annotation text that is present and associated with the guide line may also be ascertained in an automated manner and preferably stored in association with the guide line. The straight line may be advantageously provided by drawing an ellipse, whose main axis (as a straight line) lies in the direction of the longitudinal extension and whose vertices represent the end points of the ascertained guide line, in the contiguous component of the candidate. A very stable algorithm may be obtained in this way.

It is very particularly advantageous when the end point of the straight line lying within the utility article is associated with a part of the utility article. In this way, the guide line may be anchored on the correct part in any view of the utility article.

To generate additional information that is to be attributed to a movement of a part of the utility article, the movement options of at least one part of the utility article are advantageously ascertained, using a motion planning method. This may also be easily carried out using available methods.

To ascertain motion arrows in the illustration, contiguous components may be ascertained in the image, at least one contiguous component being determined which has characteristic features of a motion arrow. For a translational motion arrow, this is easily carried out by determining at least one contiguous component having exactly two concavities on its periphery. An ellipse having a main axis in the longitudinal direction of the contiguous component may once again be adapted to the contiguous component, a vertex of the ellipse that is situated closer to the concavities being interpreted as the tip of a motion arrow. A desired direction vector of a part of the utility article may be ascertained in this way.

This information may be advantageously used in that a conclusion is made concerning an indicated movement of a part of the utility article, based on the ascertained motion arrow, and at least one part of the utility article is ascertained, based on the motion planning, which is able to undergo this movement. As additional information, it may be determined here which parts of the actual utility article can be moved in this way. Views may thus be created in which a part of the utility article is illustrated as displaced and/or rotated.

Based on the movement options ascertained from the motion planning, the position of at least one part of the utility article may also be varied in the 3D model until there is sufficient alignment of the illustration with the 3D model. The type and the distance of the movement of the part may be obtained here as additional information. In this way, exploded illustrations may be displayed as views of the utility article.

To ascertain structural changes as additional information, two illustrations of the utility article may be examined, whereby a first illustration differs from a second illustration by at least one added, removed, or repositioned part of the utility article, and, based on the movement options ascertained from the motion planning, one part in the 3D model is added, one part in the 3D model is removed, or the position of at least one part in the 3D model is varied in order to arrive at the second illustration from the first illustration. This additional information may be utilized in a particularly advantageous manner for a representation of a sequence of actions to be taken on the utility article, preferably in the form of a series of views of the utility article.

To speed up this procedure, in the two illustrations it is possible to first ascertain the regions that are different, and to examine the movement options only for those parts that lie in the differing regions.

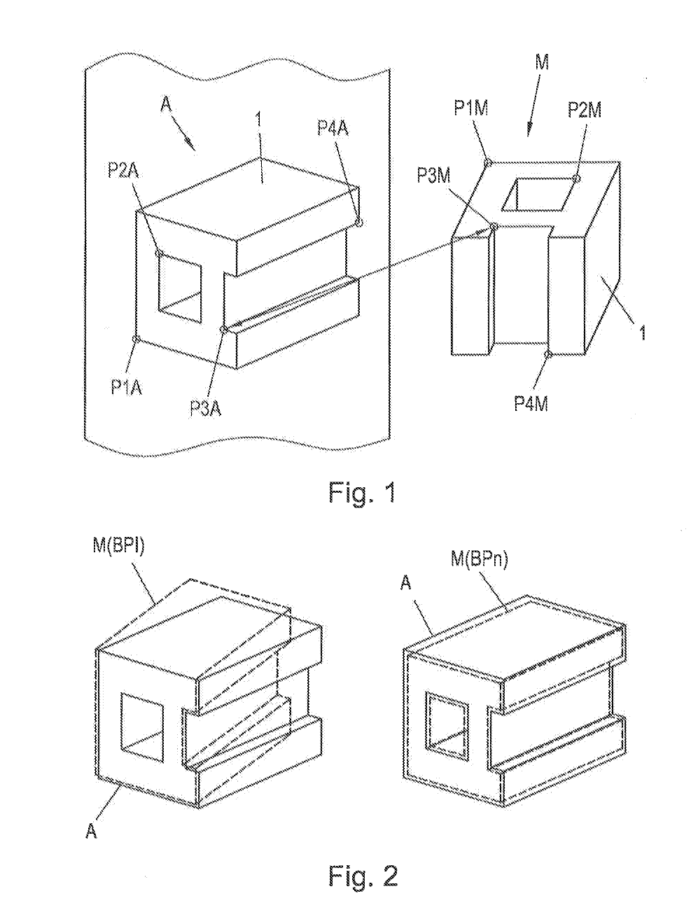

The present invention is explained in greater detail below with reference to FIGS. 1 through 16, which schematically show embodiments of the invention by way of example and without limiting the invention to same. The figures show the following:

FIGS. 1 and 2 show the procedure for determining the image parameters of an illustration in two-dimensional documentation,

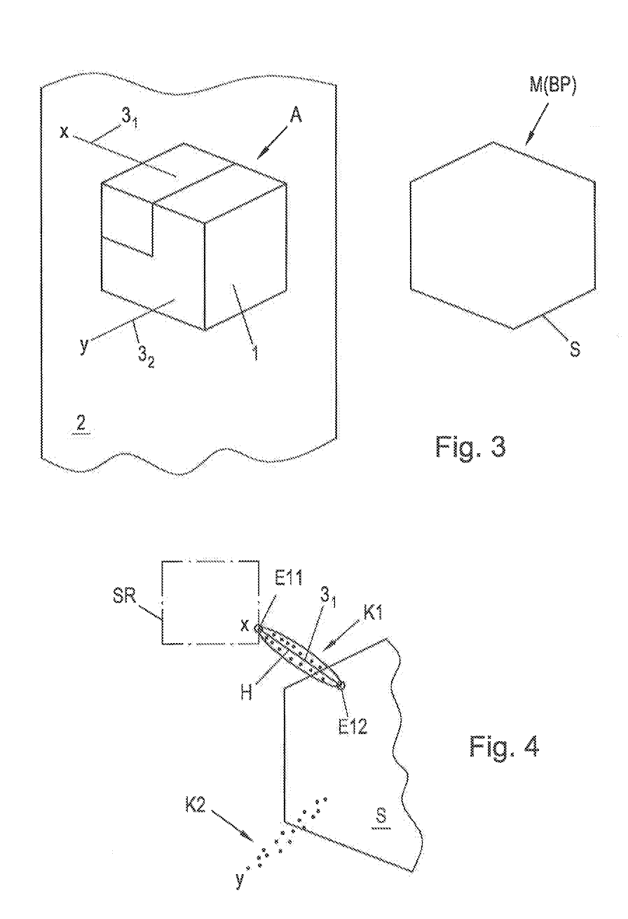

FIGS. 3 through 5 show the procedure for determining reference lines with annotations in an illustration in two-dimensional documentation,

FIG. 6 shows the basic procedure of motion planning for a part of the utility article,

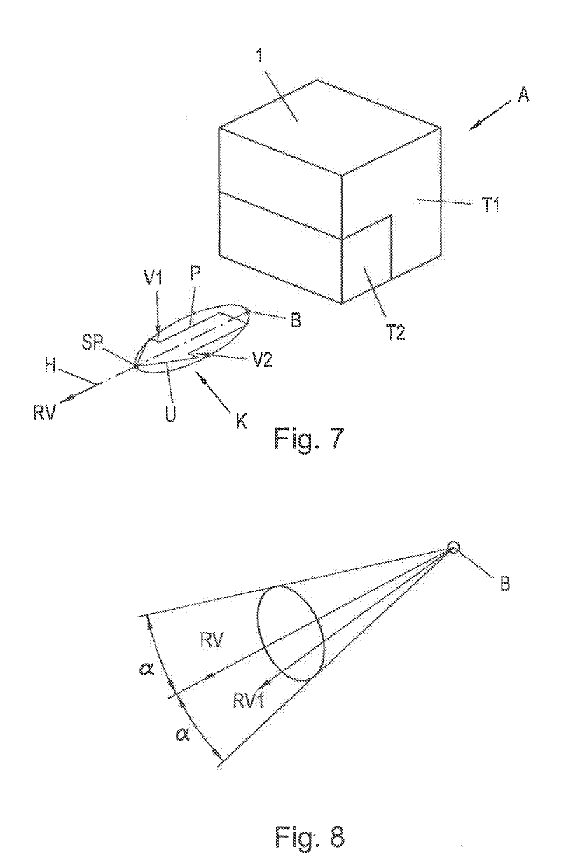

FIGS. 7 and 8 show the procedure for determining a motion arrow in an illustration in two-dimensional documentation,

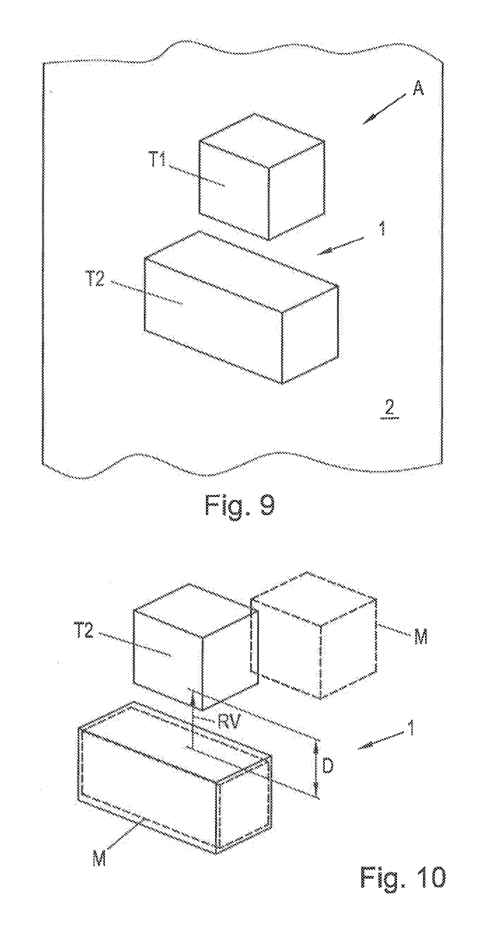

FIGS. 9 and 10 show the procedure for determining an exploded illustration in an illustration in two-dimensional documentation,

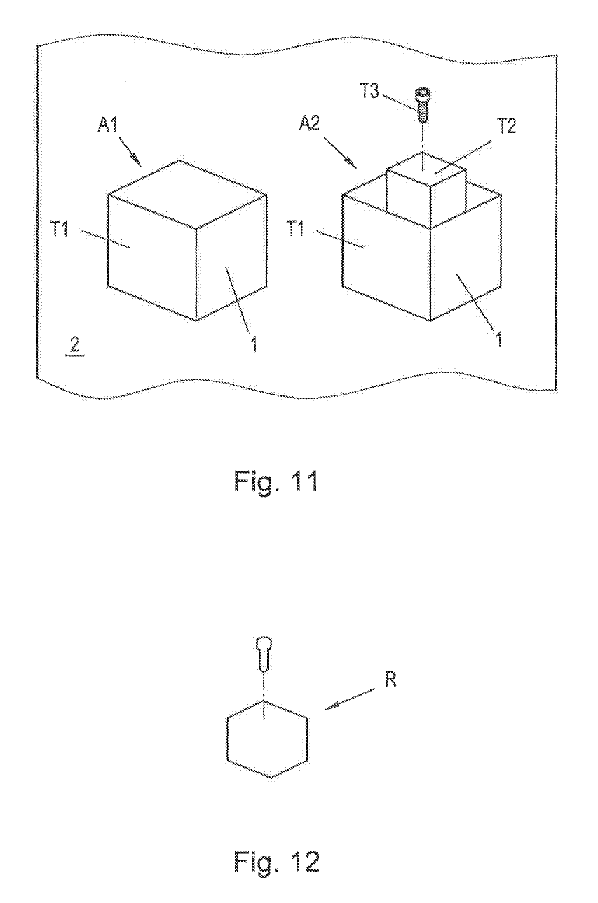

FIGS. 11 and 12 show the procedure for determining a structural representation in an illustration in two-dimensional documentation,

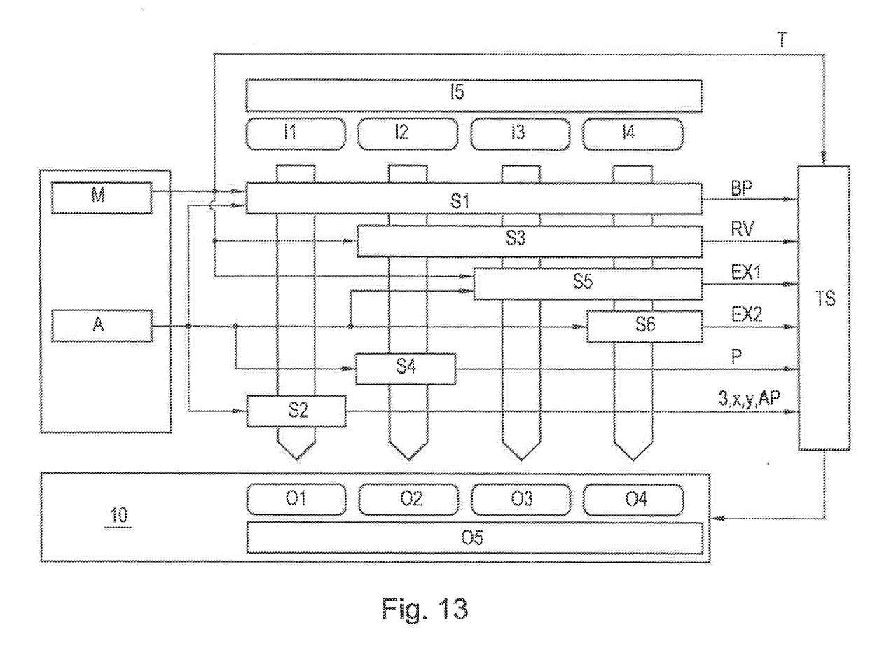

FIG. 13 shows a schematic representation of the method sequence for determining the additional information, and

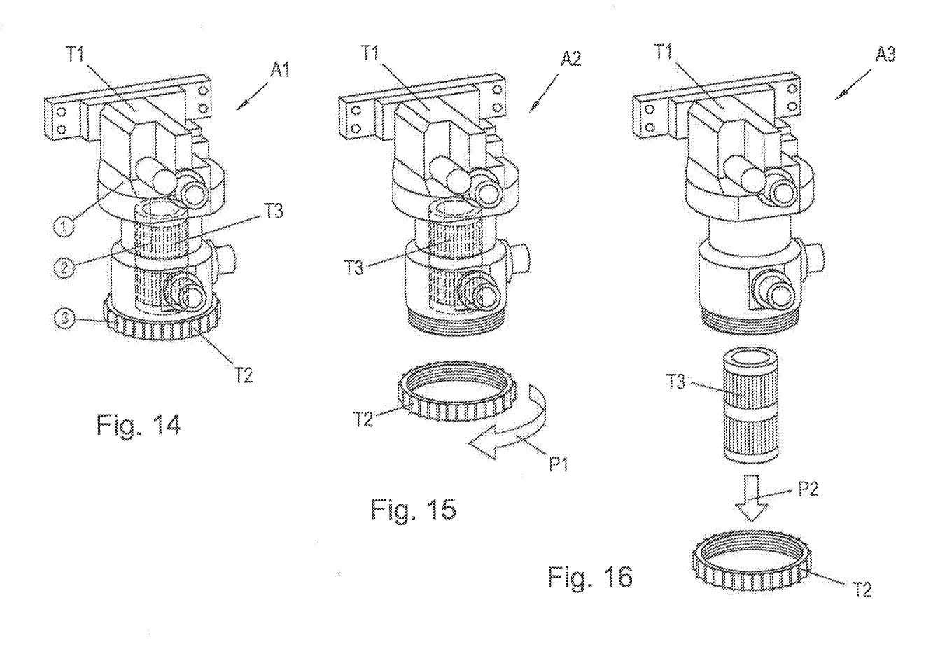

FIGS. 14 through 16 show the method based on one specific example.

An examination of existing printed, two-dimensional documentation has shown that this documentation, for the most part, includes only a limited number of types of representation of the utility article. In particular, the following types of representation are used:

a) Illustrations with Annotations

A two-dimensional illustration of a view of the utility article is shown, with addition of annotations. The annotations, by use of a reference line, refer to a specific part of the utility article. The annotations are frequently contained in the form of text or a number. Typical applications are annotations in the form of reference numerals which denote parts of the utility article, or information concerning a part of the utility article in text form. In the present and following discussions, “part of the utility article” is understood to mean an individual component, or also an assembly made up of multiple individual parts.

b) Illustrations with Motion Arrows

In this type of representation, an arrow is added in a two-dimensional illustration of a view of the utility article, which indicates a (translational or rotational) movement of a part of the utility article that is to be carried out by a user on the utility article. This type of representation is frequently used in operating manuals, service instructions, or repair instructions in order to show a user how a part of the utility article is to be used.

### c) Exploded Illustrations

In this type of representation, individual parts of the utility article are illustrated in an exploded view, i.e., separate from one another, in a two-dimensional illustration. The parts are frequently situated along an explode line in order to indicate the association of individual parts with larger assemblies and the configuration in the utility article. This type of representation is often selected to illustrate the internal structure of a utility article.

### d) Structural Representations

In this type of representation, a sequence of two-dimensional illustrations of the utility article is generally represented, whereby each illustration differs from its predecessor or successor by at least one part having been added, removed, or changed in position relative to other parts. Added, removed, or repositioned parts are also often provided with reference lines or arrows to indicate the intended point of attachment to the utility article. The various illustrations also often show an identical view of the utility article in the various configurations. This type of representation is frequently used in assembly or disassembly instructions to provide the user with step-by-step instructions for actions to take.

Of course, combinations of the above-mentioned types of representation are also found in printed documentation, which, however, does not limit the applicability of the method according to the invention described below.

The two-dimensional documentation may be present in the form of existing printed documentation with two-dimensional images, typically in the form of handbooks, operating manuals, assembly instructions, repair instructions, training documents, etc. However, within the scope of the invention it is also possible to first recreate the two-dimensional documentation for the creation of the three-dimensional documentation. For example, the utility article could be photographed in various views and configurations prior to use of the method according to the invention, and the photographs could used as two-dimensional illustrations. Both approaches are understood as two-dimensional documentation within the meaning of the present invention.

The present invention is based on creating three-dimensional documentation of a utility article 1, to the greatest extent possible in an automated manner, from existing conventional two-dimensional documentation of the utility article 1 in printed form (or in a digital equivalent as a computer file); the three-dimensional documentation may then also be used, for example, for an augmented reality application, for web-based training, or for animated documentation. For this purpose, at least one existing illustration A of the utility article 1 in the two-dimensional documentation 2 is analyzed, and information is obtained therefrom for three-dimensional documentation. To this end, the illustration A is naturally present in the documentation 2 in digital form, for example in that the illustration A in the documentation 2 is scanned in two dimensions with sufficient resolution, or the documentation 2 is already present in a digital format. It is meaningful to select the resolution corresponding to the degree of detail in the illustration.

The method for creating the augmented reality documentation is described in detail below.

A prerequisite for the method according to the invention is for a digital 3D model M of the utility article 1 to be present. The digital 3D model M may be present in the form of a 3D CAD drawing, for example. Since the documentation 2 is generally created by the manufacturer of the utility article 1, and the development and design of the utility article 1 based on or using 3D drawings is common nowadays, such a 3D CAD drawing will be available in most cases. A 3D CAD drawing has the advantage that all parts are contained and identifiable. Alternatively, a 3D scan could be made of the utility article 1. Likewise, separate parts of the utility article 1 could be scanned individually in three dimensions and subsequently combined into a 3D model of the utility article 1. 3D scanners and associated software are available for this purpose which allow such 3D scans to be made. Mentioned here as an example is the Kinect® sensor from Microsoft® in combination with the open source software package KinFu.

In the first step of the method according to the invention, the particular image parameters used to create the two-dimensional illustration A of a view of the utility article 1 in the printed documentation 2 must be ascertained, regardless of whether the illustration A is a photograph or a drawing. The two essential image parameters are the viewing position in space in relation to the utility article 1, and the focal length at which the utility article 1 was observed. Using the example of a photograph, it is clear that the image changes when the viewing position of the camera with respect to the utility article 1 is changed, or when the camera settings, above all the focal length, are changed.

For this purpose, in one possible implementation of the method a user marks a plurality, preferably four or more, of corresponding points P1A-P1M, P2A-P2M, P3A-P3M, P4A-P4M in the image A and in the 3D model M, as indicated in FIG. 1. Corresponding points P1A-P1M, P2A-P2M, P3A-P3M, P4A-P4M are identical points of the utility article 1 in the image A and in the 3D model M. Needless to say, the points P1A, P2A, P3A, P4A are represented in the image A of the utility article 1. This involves marking, at specific points P1A, P2A, P3A, P4A of the utility article 1 in the image A, the equivalents P1M, P2M, P3M, P4M in the 3D model M, as indicated in FIG. 1 by the double arrow between the points P3A, P3M. The 3D model M may be aligned with the illustration A via the corresponding points P1A-P1M, P2A-P2M, P3A-P3M, P4A-P4M in such a way that the corresponding points P1A-P1M, P2A-P2M, P3A-P3M, P4A-P4M must be superposed when overlaid on one another. Next, the focal length as the image parameter is estimated if it is not known, which is usually the case. By use of the illustration A, the corresponding points P1A-P1M, P2A-P2M, P3A-P3M, P4A-P4M, and the estimated focal length, the viewing position BP that has resulted in the illustration A of the view of the utility article 1 may be determined by means of available, well-known algorithms in digital image processing, for example the known POSIT algorithm. By superimposing the illustration A and the view of the 3D model M with the ascertained viewing position BP1, for example by a simultaneous display on a screen, the result may be verified as illustrated in FIG. 2. If the deviation is too great (left side of FIG. 2), the focal length may be changed and/or other or additional corresponding points may be selected. This may be iteratively repeated until a sufficiently precise alignment of the illustration A with the view of the 3D model M results at an ascertained viewing position BPn (right side of FIG. 2). The viewing position BP may be easily ascertained by a user, whereby the user him/herself decides when sufficient alignment has been achieved. Likewise, the viewing position BP may be ascertained using standard methods in digital image processing, such as methods for point identification and for ascertaining image alignment, alternatively in an automated manner. In particular, the focal length may also be iteratively changed in an automated manner until the best possible image alignment, and thus the sought viewing position BP that has resulted in illustration A, is obtained.

The ascertainment of the viewing position BP may be repeated for any two-dimensional illustration A of the printed documentation 2 of interest. However, it is often the case that all illustrations A of the printed documentation 2 have been created using the same image parameters. Therefore, it may also be sufficient to ascertain the image parameters only once, and to subsequently apply them to all, or at least some, illustrations A of interest.

After the two-dimensional illustration A in the printed documentation 2 and the 3D model M have been aligned as described, the illustration A may be analyzed with regard to the above types of representation. The basic procedure is that, based on the comparison of the two-dimensional illustration and a view of the 3D model with the ascertained image parameters, additional information is obtained from the two-dimensional illustration, which may then be superimposed on a view of the 3D model of the utility article, in the form of a view of the 3D model. For this purpose, the additional information is preferably associated with individual parts of the utility article 1, so that the additional information may always be correctly displayed in the particular view, even when the view is changed (for example, when the 3D model M is rotated in space).

a) Illustrations with Annotations (FIGS. 3 Through 5)

Based on the 3D model M in the view from the ascertained viewing position BP, a two-dimensional mask S (right side of FIG. 3) is created that contains all pixels of the ascertained view of the 3D model M. By use of the mask S, all pixels in the digitized illustration A (which is aligned with the view of the 3D model M) situated outside the view of the utility article 1 may now be ascertained. By use of digital image processing methods, a search is now made for contiguous components in the digitized illustration A. One possible algorithm for this purpose is the Maximally Stable Extremal Regions (MSER) algorithm, which represents an efficient method for dividing an image into contiguous components. Each contiguous component K determined in this way thus comprises a number of pixels (indicated by the points in FIG. 4) in the digitized illustration A. Of all ascertained contiguous components K, those which are able to represent a reference line 3₁, 3₂ in the image A are selected. For example, the eccentricity of the contiguous components K may be ascertained for this purpose. The eccentricity is hereby established as the ratio of the largest longitudinal extension to the largest transverse extension (normal to the longitudinal extension) of the contiguous component K. For a reference line 3₁, 3₂, it may be assumed that the eccentricity normalized to one must be approximately one. An appropriate threshold value may be defined here. Any contiguous component K1, K2 whose eccentricity exceeds this threshold value and intersects the outer boundary of the mask S, or at least contacts same (since a reference line 3₁, 3₂ must point toward a part of the utility article 1), is interpreted as a reference line 3₁, 3₂ (FIG. 4).

Next, the end points E11, E12 of a reference line 3₁, 3₂ are to be determined. For this purpose, any desired method may be used to draw a best possible straight line into the pixels of the contiguous components K1, K2 in the direction of the longitudinal extension. For example, an ellipse having a main axis H in the direction of the longitudinal extension may be fitted around the pixels of the contiguous components K1, K2, as indicated in FIG. 4 for the component K1. The vertices of the ellipse on the main axis H are then interpreted as end points E11, E12 of the sought reference line 3₁. Based on the mask S, it may now be easily determined which end point E11, E12 is situated in the area inside, and which is situated in the area outside, the utility article 1.

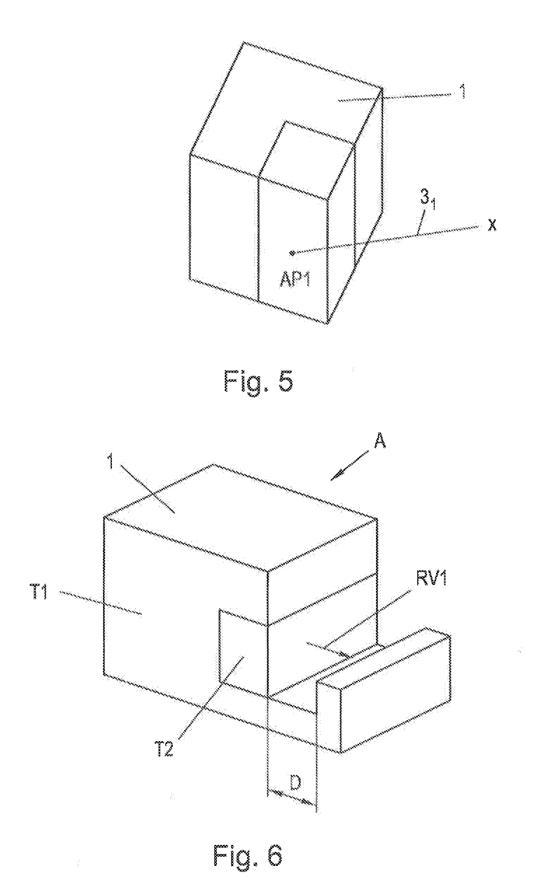

For the end point E12 inside the utility article 1, it may also be ascertained, based on the 3D model M, to which part of the utility article 1 the ascertained reference line 3₁ points. This association may also be stored in a dedicated parts memory that contains all individually identifiable parts of the utility article 1. The ascertained end point E12 inside the utility article 1, as the anchor point AP1 (FIG. 5) of the reference line 3₁ for the three-dimensional documentation, is stored, optionally together with the association with a specified part of the utility article 1, in the parts memory.

However, the anchor point AP1 may also be moved into the respective body center point of the associated part T, which may be advantageous for a subsequent three-dimensional representation of the utility article 1.

A search region SR (FIG. 4), which is searched for text or numbers, for example by means of conventional optical character recognition (OCR) software, may now be established around the end point E11 situated outside the utility article 1. Alternatively, annotation text could also be manually added to the ascertained reference line 3. The annotation text ascertained in this way is likewise stored for the reference line 3₁, for example once again in the parts memory.

If the view of the utility article 1 is now changed in an augmented reality application, for example by changing the camera position for recording the utility article 1, the superimposition of the ascertained reference line 3₁ and the associated annotation text may be correspondingly followed via the established anchor point AP1. The anchor point AP1 remains on the identified part of the utility article 1, and the other end point E11 of the reference line 3₁ with the annotation text may be positioned in the augmented reality representation at any given location, preferably a location outside the utility article 1, as illustrated in FIG. 5. Of course, the reference line 3 with annotation text may be represented in any given three-dimensional view of the utility article 1.

b) Illustrations with Motion Arrows (FIGS. 6 Through 8)

Since this involves the movement of parts T of the utility article 1, it must first be determined which parts T are individually movable at all. This information may either already be contained in the 3D model M, or may be ascertained using known methods. Such methods are known in particular from the field of motion planning for components. An examination is made concerning which parts T1, T2 of the utility article 1 in the 3D model M can be moved (translationally and/or rotationally), and if so, in which area without colliding with other parts of the utility article 1. A possible direction vector RV1 (or also multiple possible direction vectors) of a translational motion, or a rotational axis (or also multiple possible rotational axes) of a possible rotational motion, as well as the possible distance D of the motion, are ascertained, as indicated in FIG. 6 for a translational motion. Such a method is described, for example, in Lozano-Perez, T., “Spatial planning: A configuration space approach,” IEEE Trans. Comput. 32, 2 (February 1983), pp. 108-120. The information concerning the ascertained possible motions is stored for each part T1, T2 of the 3D model M, once again in the parts memory, for example.

Next, the motion arrows P in the image A must be identified, as described by way of example with reference to FIG. 7. The basic procedure is the same as described above with regard to the reference line 3. In the present case, contiguous components K outside the mask S are ascertained, since it is assumed that a motion arrow P in the image A is not represented in the utility article 1. However, the method may also be expanded to motion arrows P that intersect the illustration of the utility article 1. To recognize a possible motion arrow P in an automated manner, a search is made for contiguous components K that have characteristic features of an arrow, i.e., a tip SP, a widened area starting from the tip SP, a subsequent narrowed area, and an adjoining base. In the example according to FIG. 7, for example the contiguous components K having exactly two concavities V1, V2 on their periphery U are ascertained, which is a characteristic feature of an arrow. Once again, an ellipse having a main axis H is then adapted to the contiguous component K, the main axis H being oriented in the direction of the longitudinal extension of the contiguous component K. The vertex of the ellipse that is situated closer to the concavities V1, V2 is interpreted as the tip SP of the motion arrow P. The other vertex is then the base B of the motion arrow P. A direction vector RV of an intended movement of a part T1, T2 of the utility article 1 may be established based on the main axis H of the ellipse, and the base B and the tip SP (or one of the two).

It must now be determined which part T1, T2 of the utility article 1 is to be moved. First, the parts T2 that can be moved at all in the direction of the direction vector RV are ascertained. A search is made for the parts T2 whose direction vector RV1 of the possible movement (from the motion planning procedure described above) coincides with the direction vector RV of the motion arrow P. For this purpose, it is meaningful to establish a spatial angular range a about which the two direction vectors RV, RV1 are permitted to deviate, as indicated in FIG. 8. If multiple parts T of the utility article 1 come into consideration for the movement, it may be decided whether all parts in question are to be moved or certain parts are to be moved, or the part T2 that is closest to the base B of the motion arrow P may be selected.

An analogous procedure may be followed for motion arrows P that represent a rotational motion. Thus, the motion arrow P and the desired rotation (or rotational axis) are first identified, and the parts that are able to undergo rotation are then determined.

In an augmented reality representation, a motion arrow P may then be superimposed, for example on a recorded actual view of the utility article 1, and by clicking the motion arrow P an animation is started which animates the movement of a part T2 of the utility article 1 via the recording of the utility article 1. Here as well, the animation may be followed in real time when the viewing position is changed.

### c) Exploded Illustrations (FIGS. 9 Through 10)

To ascertain the image parameters BP of an exploded illustration, the above-described method may be applied, for example, only to one part T2 of the exploded illustration (FIG. 9), preferably a main component.

Here as well, the ascertainment of the possible movements of the parts T of the utility article 1 takes place at the beginning, as described above. By use of the ascertained image parameters BP for the illustration A in the exploded illustration (see above), the movable parts T of the utility article 1 in the 3D model M are then varied according to the specified movement options, i.e., various positions of the movable parts T are assumed (FIG. 10), and in each case a check is made concerning to what extent the illustration A and the particular view of the 3D model M with the ascertained image parameters BP are aligned. Standard digital image processing methods may likewise be used once again. In principle, any given algorithm for varying the possible movements may be implemented. Examples of such are found in Agrawala, M. et al., “Designing effective step-by-step assembly instructions,” ACM Trans. Graph. 22, 3 (2003), 828-837 or Romney, B. et al., “An efficient system for geometric assembly sequence generation and evaluation,” in Proc. of Computers in Engineering (1995), 699-712. However, performance should of course be the objective of the implemented algorithm in order to quickly obtain a result for more complex utility articles 1 having a large number of parts T with movement options. For example, a part T2 in the 3D model M could be varied according to the movement options, and the area of the view in the 3D model M containing the part T2 could be compared to the same area in the illustration 2 until satisfactory alignment of the part T2 in the 3D model M with the part T2 in the image has been achieved. This may be repeated with each part T until all parts of the exploded illustration have been identified in the correct position.

For the best possible alignment of the illustration A in the exploded illustration with the 3D model M, the information EX1 is obtained concerning how (direction vector RV, rotational axis) and how far (distance D, angle) which parts T of the utility article 1 for the exploded illustration have been moved. This information EX1 may then be stored, once again in the parts memory, for example.

This information may then be used in an augmented reality application, for example, in order to superimpose an exploded illustration of the parts T on a recording of the utility article 1, preferably by means of animated motion of the parts T necessary for this purpose.

### d) Structural Representations (FIGS. 11 Through 12)

FIG. 11 illustrates an assembly sequence of parts T1, T2, T3 on the utility article 1 by way of example, using illustrations A1, A2 of the documentation 2, in this case the part T2 together with part T3 being situated on part T1. To analyze such structural representations in an automated manner, it is possible, for example, to use a reverse assembly plan, beginning with the completely assembled utility article 1. The starting point is naturally once again the illustration A and the 3D model M aligned therewith. Similarly as for the motion planning described above, the movement options for the parts T are now examined and the parts in the 3D model M are varied until the best possible alignment has been found. For this purpose, the 3D model M is advantageously reduced to the parts that are contained in the illustrations A1, A2, which is possible in each case based on the reverse sequence. As a result, the views M1, M2 are then present which have the best possible alignment with the illustrations A1, A2, together with the information concerning which parts T2, T3 must be moved in this way to arrive at the views M1, M2. Information EX2 is thus obtained concerning how (direction vector RV, rotational axis) and how far (distance D, angle) which parts T1, T2, T3 of the utility article 1 for the structural representation have been moved between two illustrations A1, A2. This information EX2 may then be stored, once again in the parts memory, for example.

To speed up the search, it is also possible to examine only the regions R of the illustrations A1, A2 in which changes have taken place (FIG. 12). These regions R may be found, for example, by ascertaining a pixel-by-pixel difference in the displayed sequence of the illustrations A1, A2. When the illustration A1, A2 depicts the parts T1, T2, T3 as filled areas with different colors, which is often the case, the region R of the change may be easily ascertained by pixel-by-pixel subtraction and threshold value formation (in order to eliminate possible minor differences). Pixel-by-pixel subtraction is understood here to mean the subtraction of the color values of each pixel, resulting in a difference between the images. For simple line drawings as illustrations A1, A2, which likewise is frequently the case, the illustrations A1, A2 may be enhanced beforehand by first ascertaining the silhouettes of the illustration A1, A2 (i.e., the outer borders) and then filling in the background of the illustration A1, A2 outside the silhouette with a uniform color. In the case of photographs as illustrations A1, A2, other digital image processing methods may also be used to find the changing regions. One example of such is the known Scale Invariant Feature Transform (SIFT) flow algorithm described in Liu, C., Yuen, J., Torralba, A., Sivic, J., Freeman, W. T., “Sift flow: Dense correspondence across different scenes,” in Proceedings of the 10th European Conference on Computer Vision: Part III, ECCV 2008, Springer-Verlag (Berlin, Heidelberg, 2008), 28-42, which finds the pixel of a target image that is most similar to a pixel of a starting image. The above-described reverse assembly plan then has to be applied only to these regions R of the changes.

The differences in the illustrations A1, A2 may lie in disappeared, added, or repositioned parts T1, T2, T3. In the case of repositioned parts T3, the methods for analyzing exploded illustrations and/or for analyzing motion arrows already described above may be used.

A complete sequence of a structural representation may then be displayed in animated form in an augmented reality application. For this purpose, an assembly or disassembly sequence may be blended in over a recorded representation of the utility article 1, for example.

The above-described methods and the sequence for analyzing an illustration 2 of documentation of a utility article 1 are illustrated once more in FIG. 13 in an overview. The 3D model M and a two-dimensional illustration A of a view of the utility article 1 are the starting points. Information concerning the individual parts T of the utility article 1, for example a unique identification of each part T, may be stored in a parts memory TS. The image parameters BP are ascertained in the first step S1. For an illustration A with annotations 11, in step S2 the annotations x, y and the reference lines 3 are ascertained and optionally stored in the parts memory TS (possibly together with the anchor points AP) for the particular parts T. For an illustration A with motion arrows 12, for an exploded illustration 13, and for a structural representation 14, motion planning of the parts T of the utility article 1 is provided in step S3. The movement options (direction vector RV and/or rotational axis) of each part T are once again stored in the parts memory TS. For an illustration A with motion arrows 12, in step S4 the motion arrows P are identified and associated with certain parts T of the utility article 1, and this information is once again stored in the parts memory TS. For an exploded illustration 13 and a structural representation 14, the described algorithms for image comparison are used in step S5. Here as well, the obtained information EX1 (displacement, rotation of certain parts T) relating to parts is stored in the parts memory TS. For a structural representation 14 in the image A, algorithms for analyzing regions R having changes may also be used in step S6 to obtain the information EX2 concerning the parts T that have changed between two illustrations A1, A2. Under some circumstances, steps S1 through S6 are also carried out in combination, so that combinations of various illustrations 15 may be analyzed. The result is three-dimensional documentation 10 of the utility article 1 which may be adapted as needed, for example with annotations (O1), as an animation of a movement of a part T based on identified motion arrows (O2), as an exploded illustration (O3), as an assembly sequence (O4), or also as any given combination of the options (O5) described above. The information from the parts memory TS may also be used.

In addition, a specific example in the form of documentation 2 for a filter is described with reference to FIGS. 14 through 16. In a first illustration A1, the filter is depicted having the following three parts: housing T1, screw cover T2, and filter insert T3 wherein annotations and reference lines for the three parts T1, T2, T3 are also contained. A filter replacement is described via a sequence of illustrations in the form of a structural representation in illustrations A2 and A3. To this end, illustration A2 shows the screw cover T2 removed from the filter housing T1, and the required operation (unscrewing the cover) is indicated by a motion arrow P1. Lastly, illustration A3 shows the filter insert T3 removed from the filter housing, and the required operation is once again indicated by a motion arrow P2. These illustrations A1, A2, A3 may be analyzed as described above in order to create therefrom three-dimensional documentation 10, which in turn may be further used in an augmented reality application, for example.

In an augmented reality application of the utility article 1, the utility article 1 is, for example, first digitally recorded, for example by means of a digital camera, 3D scanner, etc., and the 3D model M is then aligned with the recorded view of the utility article 1. This may take place either manually or by means of known algorithms, such as the Sample Consensus Initial Alignment (SAC-IA) algorithm. The recorded view of the utility article 1 may then be supplemented as needed with the information that has been obtained from the above-described analysis of the documentation 2.

For example, annotations obtained from the printed documentation 2 may be superimposed on the particular actual view of the utility article 1. The reference line 3, starting from the anchor point AP, is illustrated in such a way that the annotations may be depicted in an optimal manner. In the case of a movement of a part T in the augmented reality (an exploded illustration or structural representation, for example), the annotations may be brought along.

Exploded illustrations or structural representations in the augmented reality may also proceed by user control, for example by the user indicating which, or how many, parts are depicted in an exploded illustration.

The representation of the augmented reality may be displayed either in fully rendered representations, or solely via the outlines over the recorded image of the utility article 1.

For the augmented reality application, it is also possible to use computer glasses with which a video of the utility article 1 is made, and the previously obtained additional information concerning the utility article 1 is superimposed as needed on the visual field of the wearer of the computer glasses.

However, the obtained three-dimensional documentation 10 may of course also be used in a virtual reality viewer, for example for training concerning the utility article 1. Various views of the 3D model M may be displayed, which may be enhanced with the obtained additional information, or in which the utility article 1 is depicted in various representations, for example in an exploded illustration. Of course, animations obtained from a structural representation, for example, may be displayed here as well.

1. A method for creating three-dimensional documentation (10) for a utility article (1) made up of multiple parts (T, T1, T2, T3), wherein
image parameters (BP) of at least one illustration (A) of the utility article (1) in existing two-dimensional documentation (2) are ascertained,
a 3D model (M) of the utility article (1) is aligned with the illustration (A) with the ascertained image parameters (BP), and
based on a comparison of the two-dimensional illustration (A) and of the 3D model (M) with the ascertained image parameters (BP) from the two-dimensional illustration (A), additional information is obtained, which together with the 3D model (M) forms the three-dimensional documentation (10) of the utility article (1).

2. The method according to claim 1, wherein a plurality of corresponding points (P1A-P1M, P2A-P2M, P3A-P3M, P4A-P4M) is selected in the illustration (A) and in the 3D model (M), and the image parameters (BP) are varied until the illustration (A) and the 3D model (M) are aligned.

3. The method according to claim 1,
contiguous components (K1, K2) are ascertained in the illustration (A),
the eccentricities of the contiguous components (K1, K2) are ascertained, and the ascertained eccentricities are compared to a predefined threshold value in order to identify at least one candidate for a reference line (31, 32),
a straight line that represents the reference line (31, 32) is drawn into the contiguous component (K1, K2) of the candidate in a longitudinal direction, and
based on a mask (S) of the utility article (1) obtained from the 3D model (M), it is ascertained which end point (E12) of the straight line lies in the utility article (1).

4. The method according to claim 3, wherein a search region (SR), which is examined for annotation text (x, y) using optical character recognition software, is defined around the other end point (E11) of the straight line.

5. The method according to claim 3, wherein an ellipse having a main axis (H) in the direction of the longitudinal extension and whose vertices represent the end points (E11, E12) of the ascertained reference line (31) is drawn in the contiguous component (K1, K2) of the candidate.

6. The method according to claim 3, wherein the end point (E12) of the straight line lying within the utility article (1) is associated with a part (T) of the utility article (1).

7. The method according to claim 1, wherein the movement options of at least one part (1) of the utility article (1) are ascertained using a method for motion planning.

8. The method according to claim 1, wherein contiguous components (K) are ascertained in the illustration (A), and at least one contiguous component (K) is determined therefrom which has the characteristic features of a motion arrow (P).

9. The method according to claim 8, wherein
at least one contiguous component (K) having exactly two concavities (V1, V2) on its periphery (U) is determined,
an ellipse having a main axis (H) in the direction of the longitudinal extension of the contiguous component (K) is fitted to the contiguous component (K), and
a vertex of the ellipse that is situated closer to the concavties (V1, V2) is interpreted as the tip (SP) of a motion arrow (P).

10. The method according to claim 8, wherein a conclusion is made concerning an indicated movement of a part (T) of the utility article (1), based on the ascertained motion arrow (P), and at least one part (T) of the utility article (1) is ascertained, based on the motion planning, which is able to undergo this movement.

11. The method according to claim 7, wherein based on the movement options ascertained from the motion planning, the position of at least one part (T) of the utility article (1) is varied in the 3D model (M) until there is sufficient alignment of the illustration (A) with the 3D model (M).

12. The method according to claim 1, wherein two illustrations (A1, A2) of the utility article (1) are examined, whereby a first illustration (A1) differs from a second illustration (A2) by at least one added, removed, or repositioned part (T2, T3) of the utility article (1), and, based on the movement options ascertained from the motion planning, a part (T2, T3) in the 3D model (M) is added, a part (T2, T3) in the 3D model (M) is removed, or the position of at least one part (T2, T3) in the 3D model (M) is varied in order to arrive at the second illustration (A2) from the first illustration (A1).

13. The method according to claim 12, wherein in the two illustrations (A1, A2), the regions (R) that are different are first ascertained, and the movement options are examined only for those parts (T2, T3) that lie in the differing regions (R).

14. A method of using the three-dimensional documentation (10) that has been ascertained according to claim 1 in order to superimpose additional information from the three-dimensional documentation (10) on a recording of a utility article (1) in an augmented reality application.

15. A method of using the three-dimensional documentation (10) that has been ascertained according to claim 1 in order to superimpose additional information from the three-dimensional documentation (10) on a view of the 3D model (M) in a virtual reality viewer.
